(19) United States
(12) Patent Application Publication
(10) Pub. No.: US 2022/0331191 A1
(43) Pub. Date: Oct. 20, 2022

(54) PORTABLE AND STEERABLE WHEELED TRANSPORTATION DEVICE

(71) Applicant: DARRIN MCARDLE, Middle Village, NY (US)

(72) Inventor: DARRIN MCARDLE, Middle Village, NY (US)

(21) Appl. No.: 17/231,772

(22) Filed: Apr. 15, 2021

(51) Int. Cl. A61H 3/00

(52) U.S. Cl. CPC A61H 3/008

(57) ABSTRACT

A transportation device including a frame with a geometry and proportions that supports the body in a way that permits free movement of the lower body and legs, unencumbered by the device itself, to propel the transportation device and enable steering of the transportation device while riding with the body partially or wholly suspended off of the ground. In a portable configuration of the transportation device, a body suspension apparatus rotates in line with a central down tube and a steering mechanism rotates adjacent the central down tube. A plurality of telescoping down tubes forming the central down tube are nested within one another to reduce the length of the central down tube.

### BACKGROUND OF THE INVENTION

### Field of the Invention

The present invention relates to wheeled transportation devices and in particular to a portable and steerable wheeled transportation device which is user propelled and suitable for recreation and commuting.

### Description of Related Art

Various forms of wheeled apparatus are known for carrying riders which apparatus are propelled by the rider. Conventional skateboards include a deck mounted to wheels at front and rear with the wheels being allowed, when the board is leaned by body weight, to turn in the direction of the lean.

U.S. Pat. No. 5,263,725 describes a skateboard including improved wheels referred to as trucks. The improved trucks utilizing coil springs disposed intermediate a baseplate and an axle holder which in combination afford to a skateboard or similar vehicle an improved balance between turning stability and turning ease. In each truck there is a yoke which includes a central body portion with end portions extending outwardly. At the distal ends of the end portions there are means for engaging skateboard wheels. A first aperture is formed in and extends through the center of the body portion. First sockets formed in a generally frustoconical shape are disposed in the body portion on opposite sides of the first aperture. These sockets have longitudinal axes directed away from the body portion, and they converge toward each other. The truck also includes a baseplate in which a second aperture is formed for receiving a pivot pin, and there are second sockets, also of generally frustoconical shape, on opposite sides of the second aperture which have longitudinal axes directed away from the baseplate. The longitudinal axes of the second sockets diverge away from each other. A truck pivot pin extends through the first aperture in the yoke and into the second aperture. Means are provided for engaging the pivot pin onto the baseplate so that the yoke is joined to the baseplate in a pivotal connection. The body portion of the yoke is disposed upon the baseplate and is rotatable thereon about the pivot pin to dispose the end portions of the yoke in an arcuate path. Coil springs are provided having first end portions disposed in the first sockets in the yoke and having second end portions disposed in the second sockets in the baseplate. Skateboards in general and even with improved trucks require skill by the user to turn the skateboard in a desired direction without falling of the deck and can lead to accidents when the user falls off the deck. Other types of user propelled steerable apparatus are known. U.S. Pat. No. 5,732,964 describes a user-propelled walking apparatus comprising a frame assembly having a pair of front wheels and a pair of rear wheels. The pair of front wheels are maintained substantially parallel to one another. An upper body and seat assembly having a seat and a movable torso support unit is mounted to the frame assembly. The movable torso support unit is allowed to rotate or pivot. The rotation or pivoting movement of the movable torso support unit is connected to a mechanical transmission for controlling steering which controls the direction of the front wheels. A gait guide system comprising a pair of independent gait guides attached to the frame assembly to limit the movement of the user's feet. This walking apparatus including a seat are cumbersome and not capable of being compacted for portability and storage after use.

U.S. Pat. No. 4,907,794 describes a foldable rolling walker. The rolling walker having an elevated horizontal cross brace and a side frame pivotally mounted at each end of the cross brace. The cross brace is mounted high and forward on the side frames. Each side frame has a front and a rear leg. A wheel is attached to each leg of the side frames to support the walker on the ground. A handle assembly is mounted at the top of each side frame so as to position the handle substantially midway between the front and rear wheels for supporting the weight of the user. The side frames pivot toward each other so that the walker can be folded substantially flat for storage or transit. This walking apparatus including a seat is intended exclusively to aide walking, cumbersome and even in a folded arrangement is not readily portable.

The German patent of the Laufmachine in 1820 described the idea of ambulation on a two or three-wheeled cycle without pedals. Similar concepts were described as the Draiesenne and Dandyhorse require a seat is often uncomfortable and undoubtedly painful to the crotch of the rider.

U.S. Pat. No. 7,900,940 describes a pedestrian cycle without pedals that supports a user as the user walks or runs and propels the cycle on a supporting surface. A saddle assembly is used to avert pressure on the perinea of the rider while allowing unobstructed leg movement as permitted in a seated position. The saddle assembly is suspended from a U-shaped, partible overhead cycle frame by a plurality of flexible and adjustable straps to allow the rider to hold his or her body vertical while leaning the cycle into a turn as he or she walks or runs. This patent has the shortcoming of requiring skill for balancing the cycle to retain the body in a vertical position and limiting the users gait by being seated. In addition, the pedestrian cycle frame and supported seat is cumbersome and not capable of being compacted for portability and storage after use.

It is desirable to have an improved transportation device which can be readily compacted into a portable object and provides easily steerable wheeled transportation having a user's weight supported by the device, without using a seat, for walking, running or ambulating in any gait as the rider propels the device with both legs on a supporting surface.

### SUMMARY OF THE INVENTION

The present invention provides a safe and fun portable human powered transportation device that is suitable for recreation and commuting. The human powered wheeled transportation device of the present invention elevates the body in a way that permits free movement of the legs or movement below the hips. This permits both legs to propel the device forward unfettered at high speed with the full power of both legs and having the benefit of near weightlessness as the device is wheeled.

In one embodiment, the body is supported or elevated and supported by the forearms in close proximity to the hips via a body suspension apparatus that places the body in a position that is both comfortable and promotes powerful propulsion. Forearms sit in a padded cradle that has an extended bar attached that is grasped in the hand. For a more upright riding position, the hands can be the prime support of the body's weight. For hand use, the hands grasp a handle which is also in close proximity to the padded forearm cradle. The forearm cradle and handle is nested in front of a padded hip cradle which permits the elbow to nest close to the hip. This nesting of the arm, elbow or hand with the hip secures a comfortable riding position to permit an extended ride duration and stronger power transmission. In one embodiment, the body suspension apparatus includes a pair of aero arm bars each coupled to a support pad. The support pad can be used to support the hips and/or arm to elevate the body. In one embodiment, the aero arm can be designed to have hand handles for riding in the upright position. In one embodiment, the forearm and hip padded cradles can be adjustable to orient each, in proximity to the other, to attain the optimal position for individual users.

The transportation device of the present invention includes a frame with a geometry and proportions that supports the body in a way that permits free movement of the lower body and legs, unencumbered by the device itself, to propel the transportation device and enable steering of the transportation device while riding with the body partially or wholly suspended off of the ground. In one embodiment, the frame can include the body suspension apparatus and a central down tube. The body suspension device is coupled to a first end of a central down tube. A single wheel or a wheeled steering mechanism, for added stability, is coupled to a second end of the central down tube.

In one embodiment, the wheeled steering mechanism comprises a deck connected to a pair of parallel wheels at a location near a first and second end of the deck. The deck is connected to an inverted C channel. When steering is activated by the turning of the central down tube, the inverted C channel enables the deck freedom of movement permitting the opposing wheels to turn, and in the same direction as the central down tube. In one embodiment, two parallel wheels are attached close together near a central portion of the deck in parallel. The parallel wheels when activated turn in the same direction as the central down tube steering direction. In one embodiment, additional parallel wheels are attached at a location forward and further apart from the central portion of the deck near a first and second end of the deck. The wheels provided at the end ends of the deck act as safety wheels. When steering is activated by the central down tube, the inverted C channel connecting the wheels, positioned at the central portion of the deck, shift forward and down thus lowering and engaging the forward positioned wheels positioned at the ends of the deck, the safety wheels, for stabilizing steering of the transportation device in sharp turns. In one embodiment, the deck is comprised of a rod that acts as an axle permitting the wheels to be mounted directly through it. The inverted C channel can have a connection to the down tube with fixed interlocking gears synchronizing their movement to prevent rollover of the transportation device from centripetal forces in sharp turns.

The central down tube nests longitudinally within a central head tube which is bearing threaded for turning of the central down tube, thereby providing easy movement of the body suspension apparatus for turning of the wheeled steering mechanism. In one embodiment, ball bearings within the central head tube provide precision steering. The central down tube can be formed of a plurality of telescopic nesting tubes that slide within one another for increasing or decreasing the length of the central down tube. The telescopic nesting tubes permit proper adjustment for size and comfort of individual users.

The frame can include a cross tube and a pair of side tubes. The cross tube is laterally mounted to the central head tube. In one embodiment, the central head tube has a perpendicular tube welded to it that nests latitudinally in a latitudinal tube in the center of the cross tube connecting them and permitting the central head tube to twist for folding while maintaining the transportation devices structural strength for riding. The latitudinally nested tubes connecting the central head and the cross tube can be of proportionate size permitting them to be secured together at their ends by a clamp. In one embodiment, the central head tube can be connected directly to the side of the cross tube via a twisting hinge with one piece of the hinge welded to each tube and connected by a central pin.

In a riding position, the central down tube is perpendicular to the cross tube. A side tube is attached to the cross tube at either end of the cross tube. A wheel is attached at a rear end of each of the side tubes.

Steering of the transportation device can be activated by the central down tube which passes through the central head tube. During operation, the body of the user is elevated or supported at the forearms or hands in close proximity to the hips via the body suspension apparatus that places the body in a position that is both comfortable and promotes powerful propulsion. The transportation device of the present invention enables steering with a combination of movement of the arms, a shift of a user's body weight and alternating pressure of the user's legs on the side tubes while cruising.

In a portable configuration of the transportation device, the body suspension apparatus rotates in line with the central down tube, the side tubes are foldable towards one another to nest below the cross tube, the plurality of telescoping down tubes forming the central down tube are nested within one another to reduce the length of the central down tube and the central down tube twists to be parallel to the cross tube. The body suspension apparatus can rotate down with both aero arm bars nesting into the central down tube.

In one embodiment, a first side tube, folds in so it is nests into the cross tube. A second side tube, folds down then in to allow the second side tube to nest with, but below, the cross tube. The second side tube can fold down first to avoid being obstructed by the first side tube that was first folded in. Hinges attach the side tubes to the cross tubes guiding the folding and maintaining alignment. Two pins, one forward and one aft, can be attached to ends of the cross tube which are the weight bearing support for the side tube at the point of connection to the cross tube. The pins are offset on each side are to permit the one side tube to fold down unobstructed. The hinges are not weight bearing in the riding position and are used to align the folding of the side tubes into the cross tube. Side tubes can clamp to the end of the cross tube to fix them in place during riding. In one embodiment, a structurally stronger hinge can be used without reliance of the structural pins.

The central head tube attached in the center of the cross tube, which is perpendicular to the central cross tube in a riding position, can twist 180 degrees so it nests with the cross tube making the transportation device more compact. In the portable configuration, the central down tube, side tubes and cross tube are nested and parallel to each other. The transportation device having compact foldability allows the transportation device to be easily portable and stored before and after use. The transportation device is structurally strong at a reasonable light weight.

In one embodiment, the frame angles the central down tube back at a pre-determined angle towards the ground. In one embodiment, an angle of central down tube angle is approximately 55 degrees. The angle of the central down tube provides unobstructed free moving leg movement, weight shifting and leg assisted steering. The angle of the central down tube can also permit the proper orientation for activation of the inverted C channel steering mechanisms.

In one embodiment, the transportation device can be oriented without the cross tube with the side tubes hinged directly to the downtube. The side tubes can be angled outward and towards the user sufficient to provide free movement of the legs. The side tubes can fold down to nest with the down tube for portability.

The invention will be more fully described by reference to the following drawings.

### BRIEF DESCRIPTION OF THE DRAWINGS

FIG. 1 is a side perspective view of a transportation device in accordance with the teachings of the present invention.

FIG. 2 is front view of the transportation device.

FIG. 3 is a top schematic view of an embodiment of a body suspension apparatus of the transportation device including hip cradles.

FIG. 4 is a schematic view of a central head tube of the transportation device

FIG. 5 is a schematic diagram of a central down tube of the transportation device.

FIG. 6 is a schematic diagram of a central head tube of the transportation device mounted to a cross tube.

FIG. 7 is a schematic diagram of the transportation device with an alternate embodiment of the central down tube.

FIG. 8A is a schematic diagram of an attachment of a first side arm to the cross tube.

FIG. 8B is a schematic diagram of attachment of the first side arm and a second side arm to the cross tube.

FIG. 8C is a schematic diagram of an attachment of the second side arm to the cross tube.

FIG. 8D is a schematic diagram of a folded position of the first side arm to the cross tube.

FIG. 8E is a schematic diagram of a downward position of the second side arm to the cross tube.

FIG. 8F is a schematic diagram of a folded position of the second side arm and the first side arm to the cross tube.

FIG. 9 is a schematic diagram of twisting of the central down tube towards the cross tube during compaction of the transportation device.

FIG. 10 is a schematic map of cross-section of folding of the side tubes.

FIG. 11 is a front view of the transportation device and a steering mechanism.

FIG. 12A is a schematic diagram of the steering mechanism shown in FIG. 11 compacted with down tube.

FIG. 12B is a schematic diagram of the central down tube parallel to the steering mechanism after rotation of the central down tube.

FIG. 13 is a schematic diagram of the central head tube for nesting within cross tube for compact folding.

FIG. 14 is a schematic diagram of the central down tube and a steering mechanism.

FIG. 15 is a schematic diagram of the central down tube connection with the steering mechanism.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

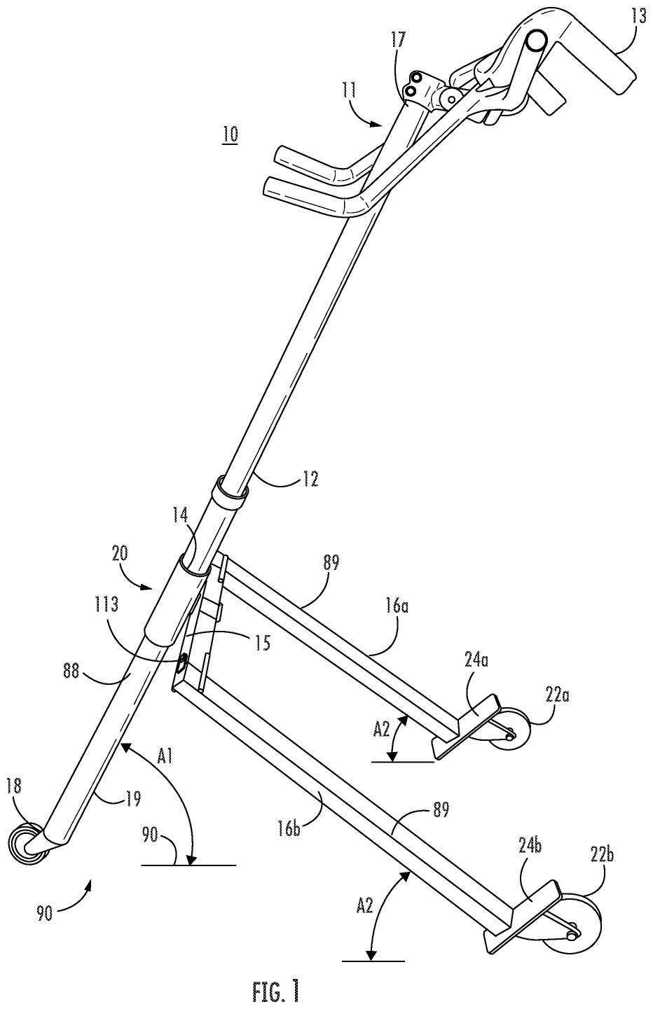

FIG. 1 illustrates transportation device 10 in accordance with the teachings of the present invention. Frame 11 includes central down tube 12 body suspension apparatus 13, central head tube 14, cross tube 15, and side tubes 16a, 16b. Body suspension apparatus 13 is coupled to first end 17 of central down tube 12. Wheel 18 is coupled to second end 19 of central down tube 12. Side tubes 16a, 16b are coupled to cross tube 15. Side tubes 16a, 16b are coupled to respective wheels 22a and 22b.

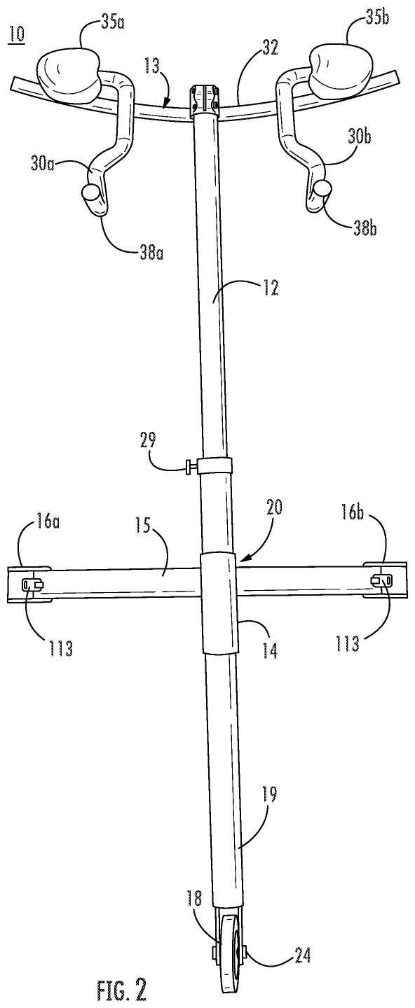

In one embodiment, body suspension apparatus 13 comprises aero bars 30a, 30b coupled to handle bar frame 32 as shown in FIG. 2. Aero bars 30a, 30b can be removably coupled to handle bar frame 32 with respective couplers 33a, 33b. Aero bars 30a, 30b can extend out a length L0, for example length L0 can be an approximate length of a forearm of a user.

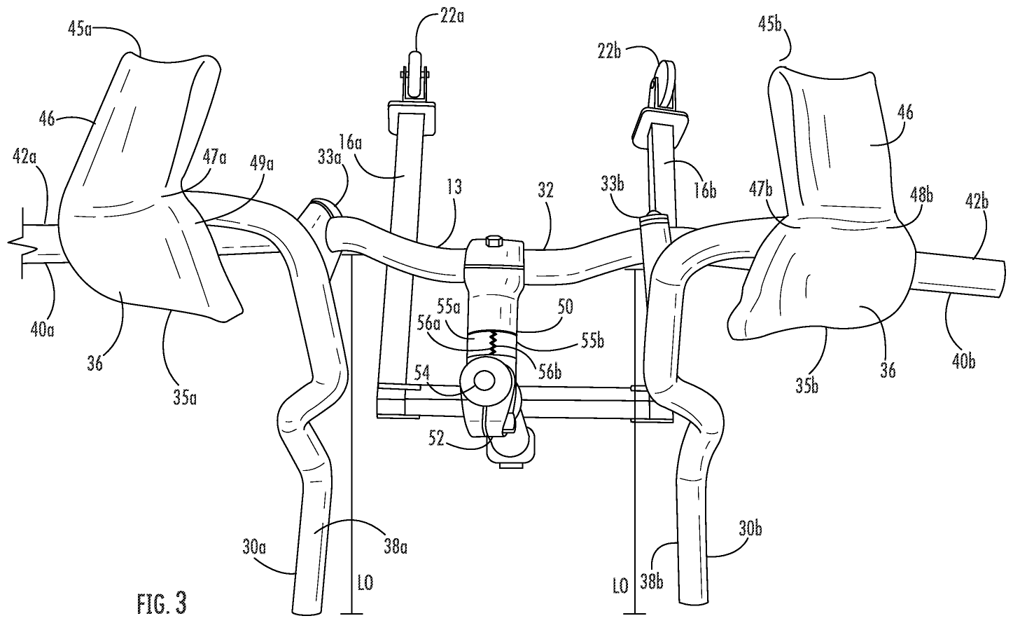

Forearm cradles 35a, 35b can be attached to respective lateral positions of aero bars 30a, 30b. Forearm cradles 35a, 35b include upper surface 36 as shown in FIG. 3. Upper surface 36 can include an indentation for supporting a received forearm of a user. Upper surface 36 can be padded. During use, forearm cradles 35a, 35b are aligned parallel with aero bars 30a, 30b, as shown in FIG. 2. Received forearms of a user are supported by forearm cradles 35a, 35b and the user can grasp handle ends 38a, 38b of aero bars 30a, 30b.

Referring to FIG. 3, body suspension apparatus 13 can include handles 40a, 40b positioned at ends 42a, 42b of respective aero bars 30a, 30b. Handles 40a, 40b can be in close proximity to respective forearm cradles 35a, 35b. Forearm cradles 35a, 35b and handles 40a, 40b can be positioned in front of hip cradles 45a, 45b. Hip cradles 45a, 45b can support a received hip bone of a user. Upper surface 46 of hip cradles 45a, 45b can be padded. Ends 47a, 47b of hip cradles 45a, 45b can be attached to rear ends 48a, 48b of forearm cradles 35a, 35b. Hip cradles 45a, 45b can be attached vertically in a longitudinal direction from forearm cradles 35a, 35b. In one embodiment, hip cradles 45a, 45b are positioned perpendicular to forearm cradles 35a, 35b. During use of forearm cradles 35a, 35b in movement of transportation device 10, the position of forearm cradles 35a, 35b and hip cradles 45a, 45b permits a received elbow of a user to nest close to a hip of the user. During use of handles 40a, 40b in movement of transportation device 10, the position of handles 40a, 40b and hip cradles 45a, 45b permits a received hand of a user to nest close to a hip of the user.

Handle bar mount 50 can be coupled to end 52 of central down tube 12 with stem 54. Stem 54 can be hinged to permit aerobars to nest in downtube. In one embodiment, stem 54 is formed of side portion 55a having serrated edge 56a and side portion 55b having serrated edge 56b. Serrated edge 56a can mate with serrrated edge 55b in a tightened positioned. Serrated edge 56a and serrated edge 56b can be released from one another to allow folding of handle bar mount 50. Central down tube 12 is attached longitudinally within central head tube 14 as shown in FIG. 1. Central head tube 14 can be bearing threaded for axle turning of central down tube 12 as shown in FIG. 5. Ball bearings can be positioned within central head tube 14 for providing movement of body suspension apparatus 13 to turn wheel 18 as shown in FIG. 1.

Central down tube 12 can be formed of nesting tubes 70 and 72 as shown in FIG. 5. Nesting tubes 70 and 72 can be telescopic. Nesting tube 70 can slide within nesting tube 72 for increasing or decreasing length L1 of central down tube 12.

In one embodiment, cross tube 15 is welded perpendicular to the central head tube 14 which nests latitudinally in a latitudinal tube in center 82 of the cross tube 15 as shown in FIG. 6. The nested tubes connect central head tube 14 to cross tube 15 permitting central head tube 14 to twist for folding while maintaining transportation device 10 structural strength for riding. The latitudinally nested tubes connecting central head tube 14 and cross tube 15 can be of proportionate size permitting them to be secured together at their ends by a clamp.

In a riding position, central down tube 14 is perpendicular to the cross tube 15 as shown in FIG. 1. Central down tube 12 can be positioned at a pre-determined angle Al towards ground 90. In one embodiment, angle A1 of central down tube 12 is in the range of about 50 degrees to about 70 degrees. In one embodiment, angle A1 is approximately 60 degrees. Side tube 16a, 16b can be attached perpendicular to cross tube 15. Central head tube 14 is mounted to central down tube 12 at a predetermined position 88 from end 19 of central down tube 12 to determine a predetermined angle A2 of side tubes 16a, 16b from ground 90. Central down tube 12 can be mounted to head tube 14 using locking clamp 29 as shown in FIG. 2. Referring to FIG. 1, the angle of side tubes 16a, 16b is determined to allow the side tubes 16, 16b to be perpendicular to cross tube 15. In one embodiment, angle A2 of side tubes 16a, 16b is in the range of about 20 degrees to 40 degrees. In one embodiment, angle A2 is approximately 30 degrees. During movement of transportation device 12, a foot of a user can be received on surface 89 of side tube 16a and/or side tube 16b. Pegs 24a, 24b can be positioned above rear wheels 22a, 22b. Pegs 24a, 24b can be used to receive a foot of a user for standing.

Steering mechanism 20 includes front wheel 18 and rear wheels 22a, 22b. Steering of the transportation device 10 can be activated by central down tube 12 which passes through central head tube 14. During operation, the body of the user is elevated or supported at the forearms or hands in close proximity to the hips via the body suspension apparatus 13. Steering mechanism 20 can be steered by shifting of body weight of the user in conjunction with alternating pressure of the feet on the inner sides of side tubes 16a, 16b. First ends 21a, 21b of side tubes 16a and 16b can be clamped to cross tube 15 to fix side tubes 16a, 16b in place during riding of transportation device 10.

Central head tube 14 can have an alternate configuration as shown in 7. Side tubes 16a and 16b extend at an angle from central head tube 14. In this embodiment, transportation device 10 is oriented without the cross tube having side tubes 16, 16b hinged directly to central head tube 14. Side tubes 16a, 16b are angled outward and towards the user sufficient to provide free movement of the legs. Side tubes 16a and 16b can fold down to nest with central down tube 12 for portability

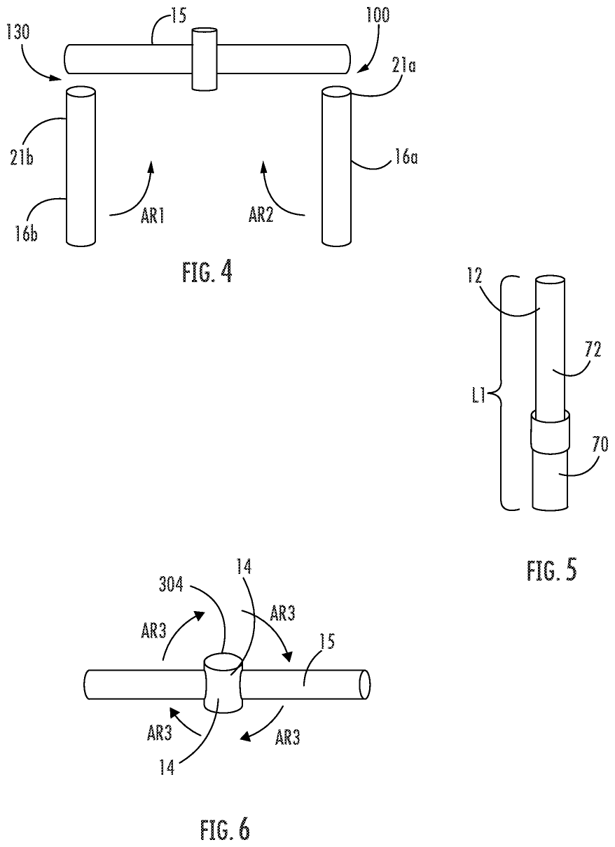

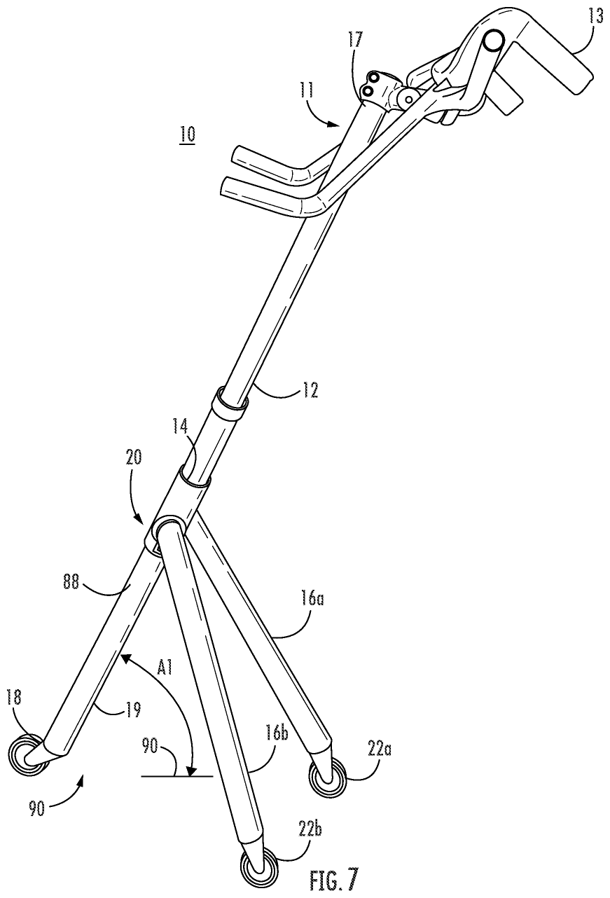

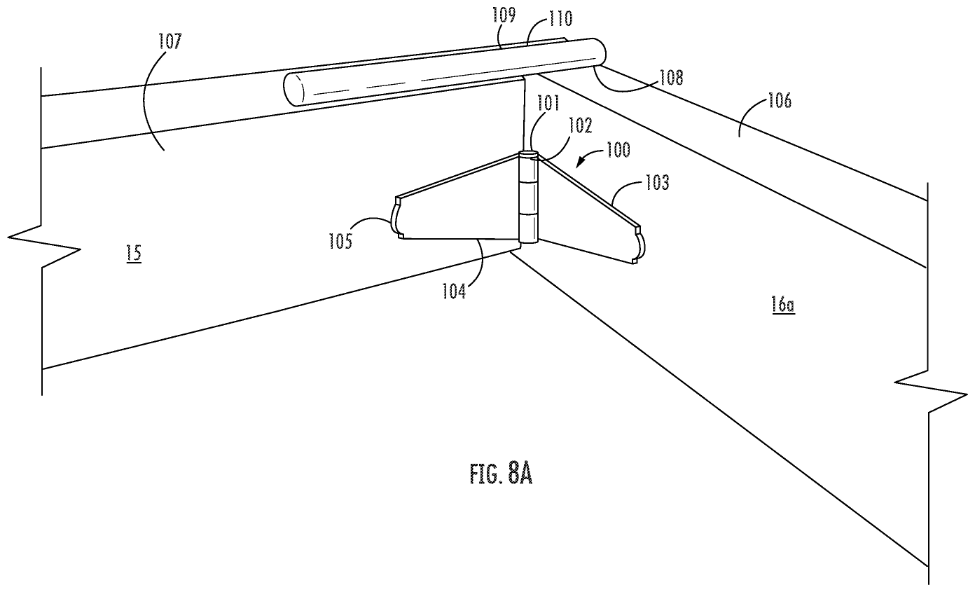

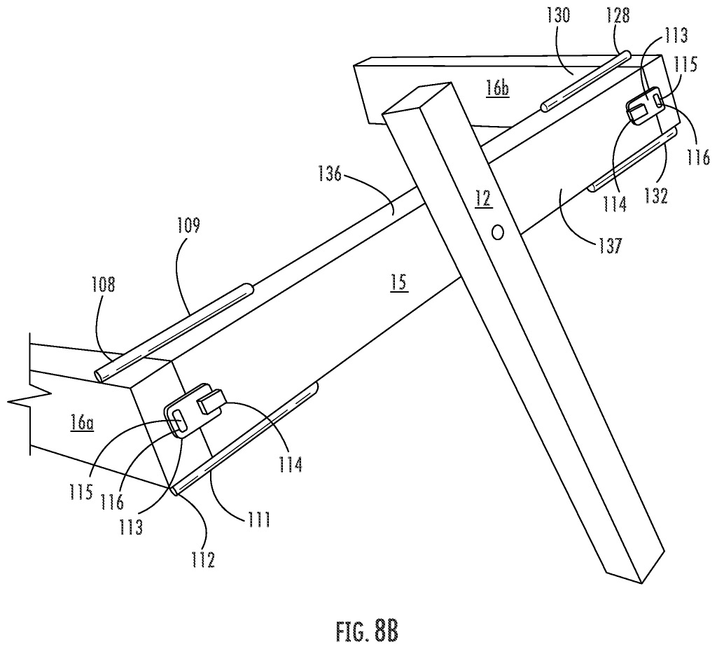

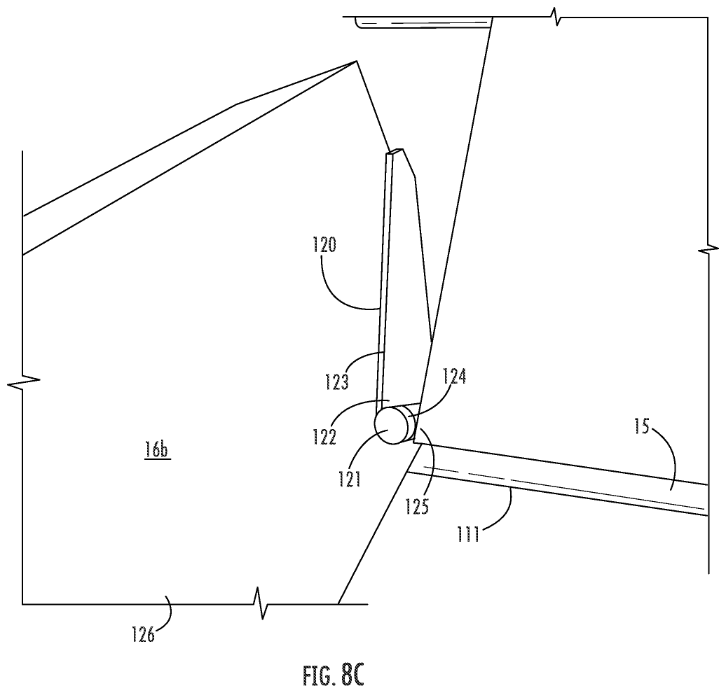

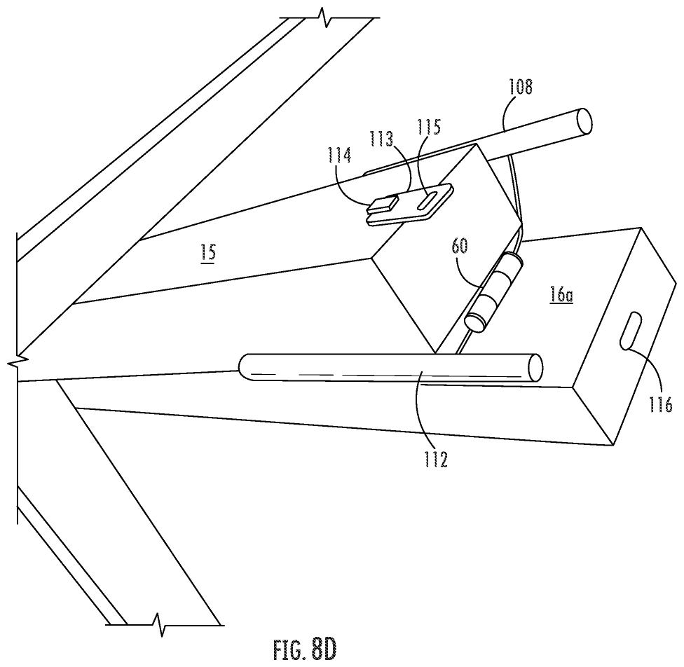

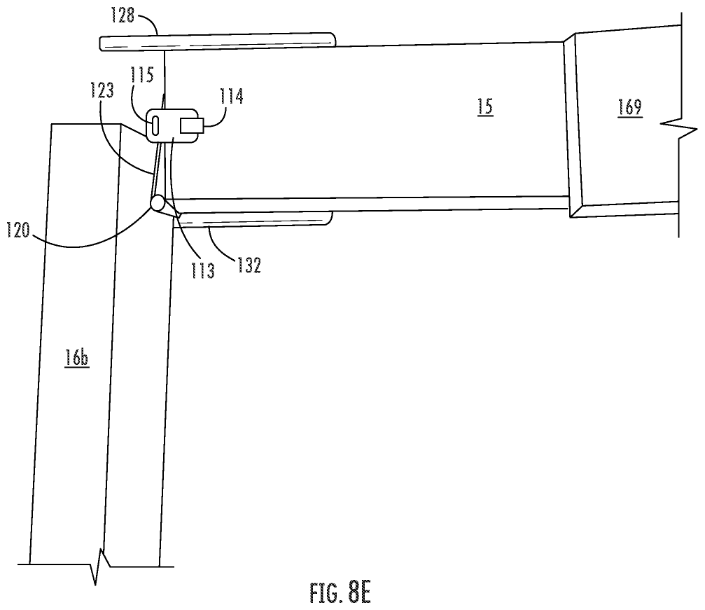

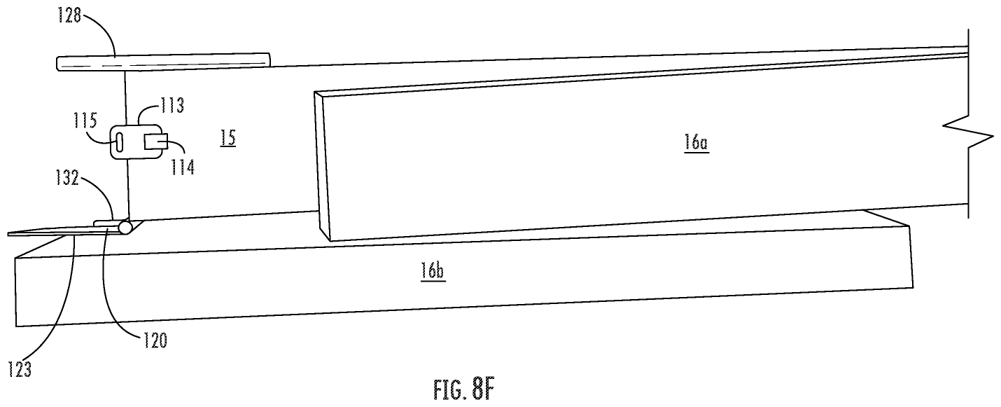

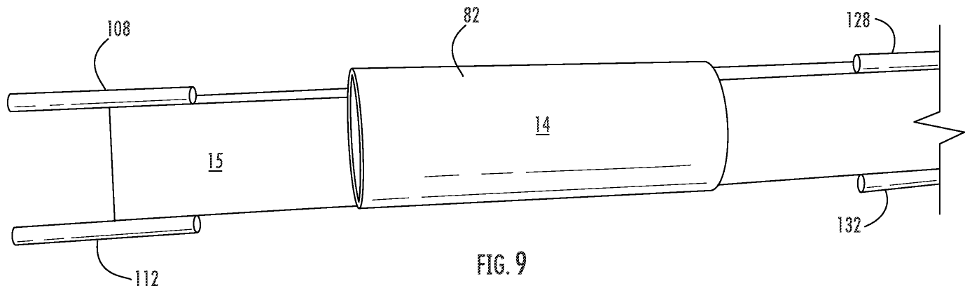

FIGS. 4, 7 and FIGS. 8A- FIG. 8F show frame 11 being foldable for providing a portable configuration for transportation device 10. In a portable configuration of transportation device 10, first ends 21a, 21b of respective side tubes 16a and 16b can be attached with hinges 100 and 102 to cross tube 15 to allow side tubes 16a and 16b to be foldable towards one another in the direction of arrows AR1 and AR2 as shown in FIG. 4.

Hinge 100 can include pin 101 as shown in FIG. 8A. Side 102 of pin 101 is coupled to plate 103 and side 104 of pin 101 is coupled to plate 105. Pin 101 rotates for allowing plates 103 to rotate inwardly and outwardly from one another. Plate 103 can be coupled to inner side 106 of side tube 16a. Plate 105 can be coupled to inner side 107 of cross tube 15.

Pin 108 can be positioned on top 109 of end 110 of cross tube 15 as shown in FIG. 8B. A partial view of central down tube 12 is shown. Pin 112 can be positioned on bottom 111 of cross tube 15 at end 110 of cross tube 15. Pin 108 and pin 112 are guides for side tube 16a during folding of cross tube 16a. Pin 108 and 112 can provide weight bearing support for side tube 16a during riding of transportation device 12 by a user.

Latch 113 is used to couple each of side tubes 16a and 16b to cross tube 15. Latch 113 includes mount 114 for attaching latch 113 to cross tube 15. Protrusion 116 extends from a portion of side tube 16a, 16b. Protrusion 116 is received in opening 115 of latch 113 during latching of side tubes 16a and 16b to cross tube 15 as shown in FIG. 8B, Protrusion 116 is removed from opening 115 of latch 113 to unlatch side tube 16a as shown in FIG. 8D and to unlatch side tube 16b as shown in FIG. 8E.

Hinge 120 can include pin 121 as shown in FIG. 8C. Side 122 of pin 121 is coupled to plate 123 and side 124 of pin 121 is coupled to plate 125. Plate 123 can be coupled to inner side 126 of side tube 16b. Plate 125 can be coupled to bottom 111 of cross tube 15. Pin 128 can be positioned on top 109 of end 130 of cross tube 15 as shown in FIG. 8B. Pin 132 can be positioned on bottom 111 of cross tube 15 at end 130 of cross tube. Pin 128 and pin 132 are guides for side tube 16b during folding of cross tube 16b. Pin 128 and 132 can provide a weight bearing support for side tube 16b during riding of transportation device 12 by a user. Pin 128 can be positioned adjacent inner side 136 off cross tube 15. Pin 132 can be positioned adjacent outer side 137 of cross tube 15. Pins 128 and 132 are offset on each side of cross tube 16 to allow side tube 16b to fold downward. unobstructed. Hinge 100 and hinge 120 are not weight bearing in a riding position of transportation device 12 and are used to align the folding of side tubes 16a and 16b adjacent to cross tube 15.

During compacting of transportation device 12 for portability, side tube 16a folds inwardly to be aligned parallel to cross tube 15 in a folded position as shown in FIG. 8D. Side tube 16b rotates downwardly to be perpendicular to cross tube 15 as shown in FIG. 8E. After side tube 16b extends downwardly, side tube 16b folds inwardly to be aligned parallel to cross tube 15 and positioned below cross tube 15 and side tube 16a in a folded position as shown in FIG. 8F. Side tube 16b can fold down first to avoid being obstructed by side tube 16a which was first folded toward cross tube 15.

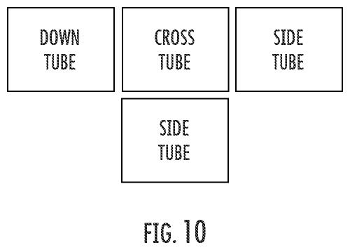

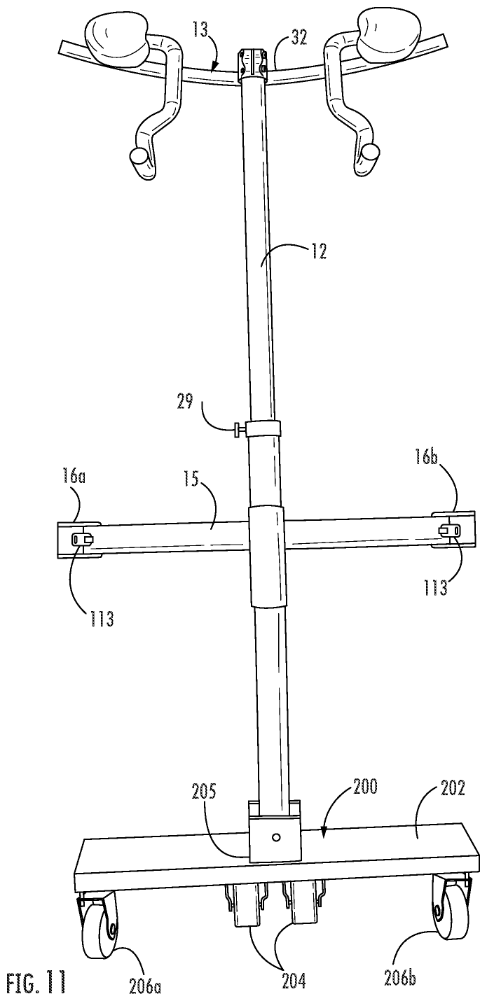

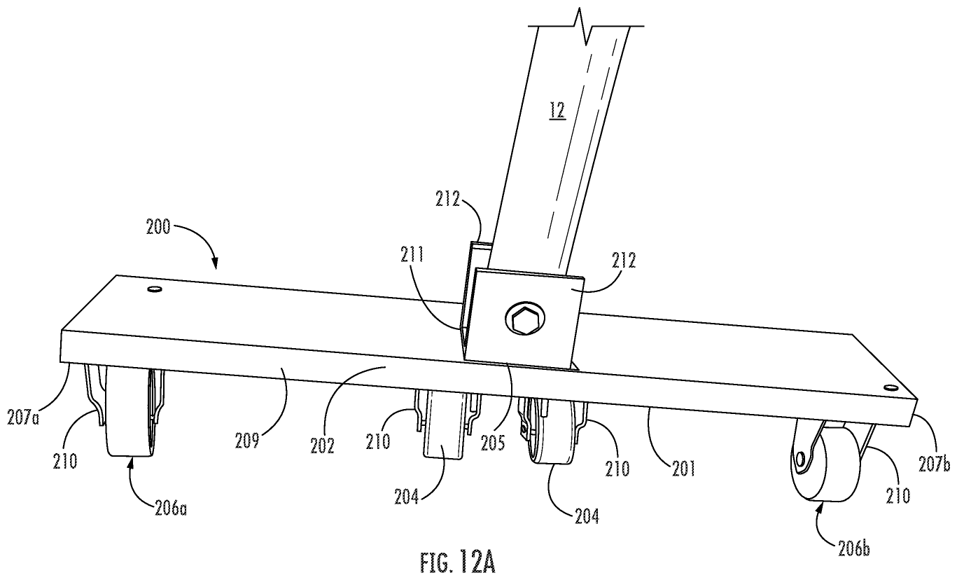

After nesting of side tubes 16a, 16b with cross tube 15, nesting tube 70 can slide within nesting tube 72 decreasing length L1 of central down tube 14 as shown in FIG. 5. Aero arm 30a and aero arm 30b can rotate adjacent central down tube 12. Body suspension apparatus 13 rotates parallel to central down tube 12. Central head tube 14 attached in the center of cross tube 15, which is perpendicular to the central down tube 12 in a riding position, can twist 180 degrees as shown in FIG. 9. Cross tube 15 can twist by rotating fitting 82 to position central down tube 12 parallel to cross tube 15 as shown in FIG. 10. In the compact position of transportation device 10, central downtube 12 is positioned adjacent top 109 of cross tube 15. Side tube 16a is positioned aside of cross tube 15. Side tube 16b is positioned adjacent bottom 111 cross tube 15 and side tube 16a. In one embodiment, in a compact position of transportation device 10, transportation device 10 frame 11 can be folded to a length less than about 2 feet and a width less than about 8 inches.

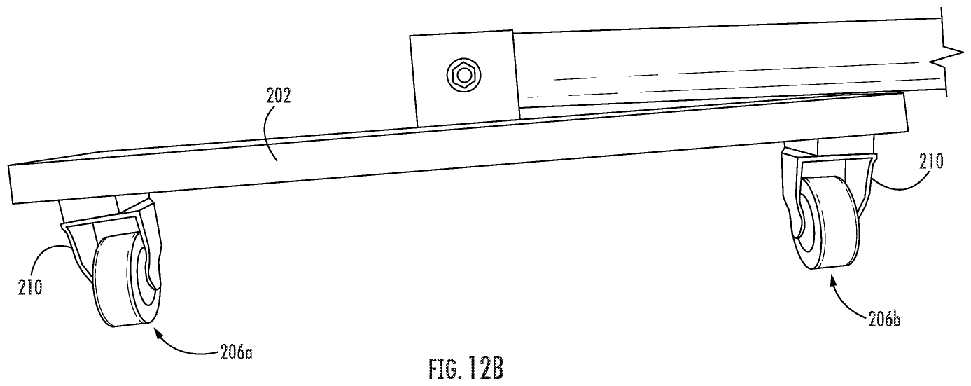

In one embodiment, wheeled steering mechanism 200 replaces wheeled steering mechanism as shown in FIG. 12A. Wheeled steering mechanism 200 comprises deck 202 connected to a plurality of wheels 204 and a plurality of outer wheels 206.

Wheels 204 can be attached to deck 202 at central portion C channel 205 of deck 202. In one embodiment, two inner wheels 204 are attached near central portion C channel 205 of deck 202 in parallel. One or more outer wheels 206a can be attached to deck 202 and positioned at end 207a of deck 202. One or more outer wheels 206b can be attached to deck 202 and positioned at end 207b of deck 202. Wheels 204 can be positioned beneath central down tube 12. Outer wheels 206a, 206b can be positioned adjacent front side 209 of deck 202 to place outer wheels 206a, 206b forward of inner wheels 204. Alternatively, only a pair of outer wheels 206a, 206b can be positioned at either end of deck 202 as shown in FIG. 12B.In one embodiment, outer wheels 206a, 206b can be attached to bottom surface 201 of the deck 202 with plate casters 210 as shown in FIG. 12B.

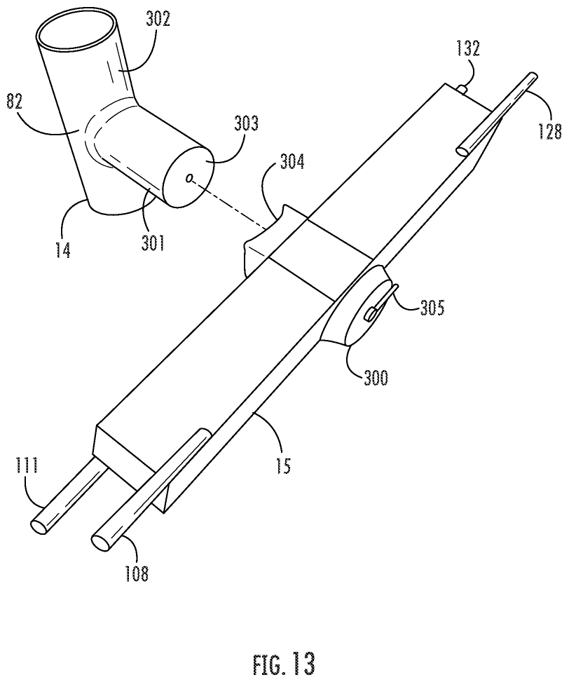

In one embodiment, central head tube 14 can be removably attached to cross tube 15 using mount 300 as shown in FIG. 13. Central head tube 14 includes lateral portion 301 and vertical portion 302. End 303 of lateral portion 301 can be received in lateral tube 304 of mount 300. Lateral portion 301 can be secured within lateral tube 304 using clamp 305 for attaching central head tube 14 to cross tube 15 .

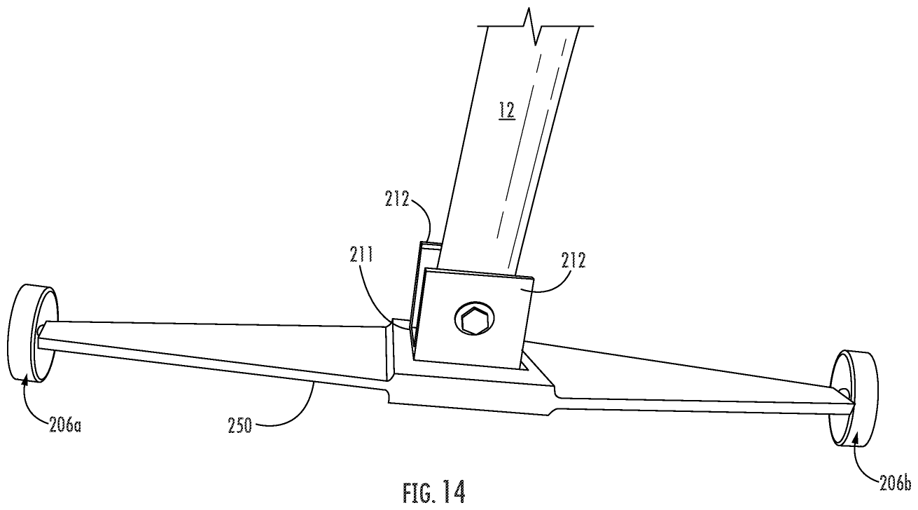

In one embodiment, the deck 202 could consist of circular rods acting as axils with the center of the wheels 206a or 206b mounted directly through the rods as shown in FIG. 14. Wheeled steering mechanism 200 comprises axle 250 connected to a pair of wheels 206a, 206b at a location near a first and second end of axle 250 as shown in FIG. 14. Central portion C channel 205 is coupled or integral with axle 250. When steering is activated by the turning of the central down tube 12, central portion C channel 205 enables axle 250 the freedom of movement permitting the opposing wheels 206a. 206b to turn, and in the same direction as central down tube 12.

Frame 11 can be compacted as described above for nesting central down tube 12, central head tube 14, cross tube 15 and side tubes 16a, 16b with deck 202 or axle 250.

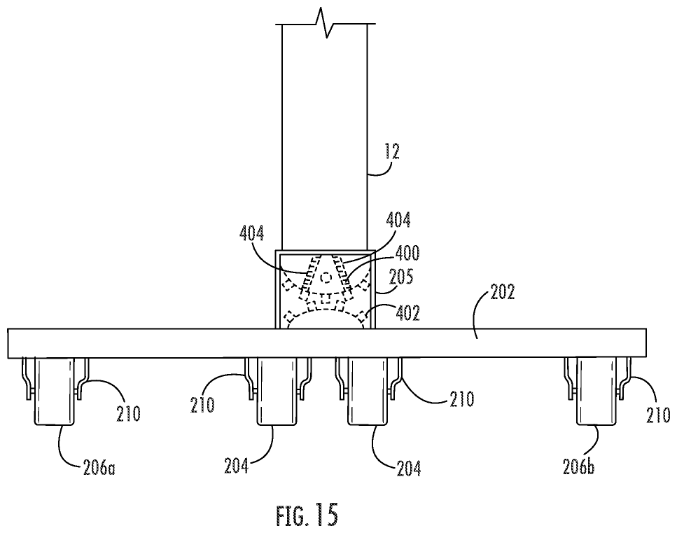

Connecting plate 211 of C channel 205 attaches to deck 202. Arms 212 of C channel 205 extend from plate 211. C channel 205 can have a connection to the down tube 12 with fixed interlocking gear 400 attached to it and gear 402 attached to C channel 205 as shown in FIG. 15 for synchronizing their movement to prevent rollover of transportation device 10 from centripetal forces in sharp turns.

Referring to FIG. 12A, wheels 204 which are parallel to one another turn in the same direction as a steering direction of central down tube 12. When steering is activated by central down tube 12, C channel 205 connecting wheels 204 shifts forward and down thus lowering and engaging forward positioned outer wheels 206a, 206b positioned at ends 207a, 207b of deck 202 to ground 90, shown in FIG. 1, in order to allow outer wheels 206a, 206b to act as safety wheels for stabilizing steering of transportation device 10 such as, for example, in sharp turns. Referring to FIG. 15, springs 404 of C channel 205 can be connected between gears 400 and 402 to dampen turning.

Central down tube 12 can be rotatably attached to wheeled steering mechanism 200 as shown in FIGS. 12A-12B. During compacting for portability of transportation device 10 including steering mechanism 200, central down tube 12 is rotated towards deck 202 as shown in FIG. 12B until central down tube 12 is adjacent the top surface of deck 202.During riding of transportation device 10, central downtube 12 can be locked in a vertical position.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed:

1. A transportation device comprising:
a frame, the frame including a body suspension apparatus coupled to a first position of a central down tube, the body suspension apparatus includes a pair of aero arm bars, each of the aero arm bars being coupled to a support pad; and
a steering mechanism coupled to a second position of the central down tube, the steering mechanism comprising a plurality of wheels,
wherein the support pad is configured to support hips and/or arms of a user to elevate a body of the user, the steering mechanism is configured to support legs of the user and the central down tube activating the steering mechanism to enable steering of the transportation device while riding with the body partially or wholly suspended by the body suspension apparatus.

2. The transportation device of claim 1 wherein the steering mechanism comprises a cross tube laterally coupled to the central down tube, a first side tube coupled to a first end of the cross tube and a second side tube coupled to a second end of the cross tube.

3. The transportation device of claim 2 wherein the cross tube is removable attached to the central down tube with a mount, the mount including a lateral portion and a vertical portion, an end of the later portion received in a lateral tube of the mount.

4. The transportation device of claim 2 wherein cross tube is coupled to allow the central down tube to twist and the first side tube and second side tube are coupled to allow the side tubes to fold towards the cross tube and nest parallel to each other adjacent to the central down tube, wherein the cross tube is perpendicular to the central down tube during riding and rotates adjacent the central down tube to compact the transportation device.

5. The transportation device of claim 4 wherein the first side tube and second side tube are coupled to the cross tube with a hinge attached respectively to each of the first side tube and the second side tube and the cross tube, the hinge being connected respectively to each of the first side tube and the second side tube and the cross tube with a pin.

6. The transportation device of claim 5 further comprising a latch to couple the first side tube and the second side tube to the cross tube.

7. The transportation device of claim 1 wherein the steering mechanism comprises a first of the wheels coupled to an end of the central down tube opposite of the body suspension apparatus, a second of the wheels coupled to a second end of the first side tube and a third of the wheels coupled to a second end of the second side tube.

8. The transportation device of claim 7 further comprising a first lug above the second of the wheels and a second lug above the third of the wheels.

9. The transportation device of claim 1 wherein each of the aero arm bars include a forearm cradle, the forearm cradle having an indention configured to receive a forearm of the user.

10. The transportation device of claim 9 wherein each of the aero arm bars includes a handle at an end of the aero arm bar and adjacent to the forearm cradle.

11. The transportation device of claim 1 wherein the steering mechanism comprises a deck and an outer pair of the wheels are positioned parallel at each end of deck.

12. The transportation device of claim 11 wherein a C channel attaches the deck to the central down tube, the C channel including a pair of arms integral with a plate, the arms being coupled to the central down tube and the plate being coupled to the deck.

13. The transportation device of claim 12 further comprising an inner pair of the wheels positioned parallel and adjacent the central down tube, the outer pair of the wheels being positioned forward of the inner pair of the wheels, wherein steering is activated by the central down tube and the C channel shifting forward and down for lowering and engaging the outer pair of the wheels.

14. The transportation device of claim 1 wherein the steering mechanism comprises a central head tube, a first side tube and a second side tube extending at an angle from the central head tube, a first of the wheels coupled to an end of the central down tube opposite of the body suspension apparatus, a second of the wheels coupled to a second end of the first side tube and a third of the wheels coupled to a second end of the second side tube.

15. The transportation device of claim 14 comprises a first of the wheels coupled to an end of the central down tube opposite of the body suspension apparatus, a second of the wheels coupled to a second end of the first side tube and a third of the wheels coupled to a second end of the second side tube.

16. The transportation device of claim 14 wherein the first side tube and the second side tube fold down to nest with the central down tube.

17. The transportation device of claim 1 wherein the central down tube comprises a plurality of nesting tubes, a first of the nesting tubes slides within a second of the nesting tubes for decreasing the length of the central down tube and a clamp for coupling the second of the nesting tubes to the first of the nesting tubes at a predetermined position.

18. The transportation device of claim 1 the body suspension apparatus is coupled to the central down tube with a handle bar mount, the handle bar mount including a stem, the stem is formed of a pair of side portions each having a serrated edge.

19. A method for providing transportation comprising:
providing a transportation device, the transportation device comprising a frame, the frame including a body suspension apparatus coupled to a first position of a central down tube, the body suspension apparatus includes a pair of aero arm bars, each of the aero arm bars being coupled to a support pad and a steering mechanism coupled to a second position of the central down tube, the steering mechanism comprising a plurality of wheels;
supporting hips and/or arms of a user with the support pad to elevate a body of the user;
supporting legs of the user on the steering mechanism; and
the central down tube activating the steering mechanism and by shifting weight of the body enables steering of the transportation device while riding with the body partially or wholly suspended by the body suspension apparatus.
